(19) United States
(12) Patent Application Publication
(10) Pub. No.: US 2016/0112572 A1
(43) Pub. Date: Apr. 21, 2016

(54) CONFERENCE CALL MANAGEMENT SYSTEM

(71) Applicant: Salesforce.com, Inc., San Francisco, CA (US)

(72) Inventors: Billy Ma, Berkeley, CA (US); Yujing Chen, San Francisco, CA (US); Rajan Patel, San Francisco, CA (US)

(21) Appl. No.: 14/515,596

(22) Filed: Oct. 16, 2014

(51) Int. Cl. H04M 3/56

(52) U.S. Cl. CPC H04M 3/56

(57) ABSTRACT

A method of establishing a conference call includes extracting conference identification information from event data. The conference identification information including a set of candidate conference numbers, a set of candidate access codes, and a set of dialing format tokens. The conference identification information is classified into a plurality of tiers based on whether the set of candidate conference numbers includes a valid conference number, whether the set of candidate access codes includes a corresponding valid access code, and whether the set of dialing format tokens includes a corresponding valid dialing format token. The conference identification information is promoted to a first tier of the plurality of tiers from a second tier of the plurality of tiers by augmenting the conference identification information with supplemental information provided by a user.

### TECHNICAL FIELD

Embodiments of the subject matter described herein relate generally to computer systems, and more particularly, to methods and systems for managing and establishing conference calls in in such computer systems.

### BACKGROUND

Recent years have seen a dramatic increase in the use of conference calls for sharing information between both small and large groups of people. Such conference calls are conveniently scheduled and established using conventional enterprise systems and software. For example, conference call information may be incorporated into an e-mail or calendar entry such that the user can easily find the conference number as well as any access code that is required. Such conference call information may take the form of a hyperlink that can be easily selected by the user, or might consist of standard text designating the appropriate conference number, access code, and any other tokens that are required.

It would be desirable for a user to have the ability to establish a conference call in a universal and transparent manner, i.e., without having to examine the conference event data (e.g., an e-mail message or calendar entry) and manually retrieve the conference number and access code information required. Unfortunately, given the large number of conference call vendors in the market, it is intractable to capture all possible formats that may exist at any given time, as each vendor will typically use their own unique conference number format, including a wide range of character strings, tokens, and patterns.

Accordingly, methods and systems are desired for improving the management and initiation of conference calls.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary conference call system in accordance with one or more embodiments;

FIG. 2 is a flow diagram of an exemplary conference call classification process suitable for implementation by the system of FIG. 1 in accordance with one or more embodiments;

FIG. 3 depicts an exemplary conference call format in accordance with various embodiments;

FIG. 4 depicts a multi-tier classification system in accordance with various embodiments.

FIG. 5 is a flow diagram of an exemplary process for establishing a conference call in accordance with various embodiments;

FIGS. 6-8 depict an exemplary user interface provided to promote conference call identification information in accordance with various embodiments.

FIG. 9 depicts an exemplary multi-tenant system suitable for implementation of the conference call methods described herein.

### DETAILED DESCRIPTION

Embodiments of the subject matter described herein generally relate to improved systems and method for establishing conference calls. As described in greater detail below, in accordance exemplary embodiments, conference call information is first extracted from event data (e.g., a calendar entry relating to an impending conference call, or an e-mail including some form of conference call information). The conference identification information will generally include a set of candidate conference numbers, a set of zero or more candidate access codes, and a set of zero or more dialing format tokens (i.e., one or more numbers or special characters required by the particular conference call vendor to correctly establish a conference call). The resulting conference identification information is then classified into a plurality of “tiers” based on whether the conference identification information includes a valid conference number, a corresponding valid access code, and/or a corresponding valid dialing format token. Through user interaction (e.g., by presenting one or more menu selections to the user), the conference identification information is promoted from a lower tier (e.g., in which only a valid conference number is known) to a higher tier (e.g., in which a valid conference number, a corresponding valid access code, and any corresponding vendor tokens are known). Promotion takes place by “augmenting” the initial, deficient conference identification information with supplemental information provided by the user. The augmented conference identification information can then be stored for later retrieval by the system, thereby greatly improving the user experience (i.e., reducing the number of dialing steps required by the user) and allowing a wide range of vendor dialing formats to be recognized. Furthermore, as the classified conference identification information can be stored locally—for example, on the user's mobile device—the conference call can be established while the mobile device is in an offline mode.

In accordance with one embodiment, a method of establishing a conference call includes receiving event data, extracting conference identification information from the event data, the conference identification information including a set of candidate conference numbers, a set of candidate access codes, and a set of dialing format tokens, and then classifying the conference identification information into a plurality of tiers based on whether the set of candidate conference numbers includes a valid conference number, whether the set of candidate access codes includes a corresponding valid access code, and whether the set of dialing format tokens includes a corresponding valid dialing format token. The method continues with promoting the conference identification information to a first tier of the plurality of tiers from a second tier of the plurality of tiers based upon first supplemental information provided by a user, and establishing the conference call based on the augmented conference identification information.

A conference call management system in accordance with one embodiment includes an extraction module, a classification module, a promotion module, and a dialer module. The extraction module is configured to receiving event data and extract conference identification information therefrom, the conference identification information including a set of candidate conference numbers, a set of candidate access codes, and a set of dialing format tokens; The classification module is configured to classify, with a processor, the conference identification information into a plurality of tiers based on whether the set of candidate conference numbers includes a valid conference number, whether the set of candidate access codes includes a corresponding valid access code, and whether the set of dialing format tokens includes a corresponding valid dialing format token. The promotion module configured to promote the conference identification information to a first tier of the plurality of tiers from a second tier of the plurality of tiers based upon first supplemental information provided by a user. The dialer module is configured to establish the conference call based on the augmented conference identification information.

Referring now to the conceptual block diagram of FIG. 1, a conference call management system (or simply “system”) 100 in accordance with various embodiments includes an extraction module 102, a classification module 104, a promotion module 106, and a dialer module 108. In general, as described in further detail below, extraction module 102 is configured to receive conference call event data (or simply “event data” 101) and extract conference identification (“ID”) information 110 therefrom. Classification module 104 then classifies (e.g., categorizes into discrete “tiers”) conference ID information 110 based, generally, on how complete the information is—i.e., whether and to what extent conference ID information includes valid conference telephone numbers, valid access codes, and/or valid vendor token information. Subsequently, promotion module 106 “promotes” conference ID information 110 from one tier to another through a combination of user interaction and/or querying a database 130 of previously successful teleconference numbers. Promoting the conference identification information to a higher tier from a lower tier generally includes “augmenting” (i.e., adding to) the conference call information using supplemental information provided by a user (e.g., the desired phone number and/or access code), thereby producing “augmented” conference identification information. Dialer module 108 (e.g., suitable hardware and/or software resident within a mobile device, or the like) then uses the augmented conference ID information to establish the telephone conference.

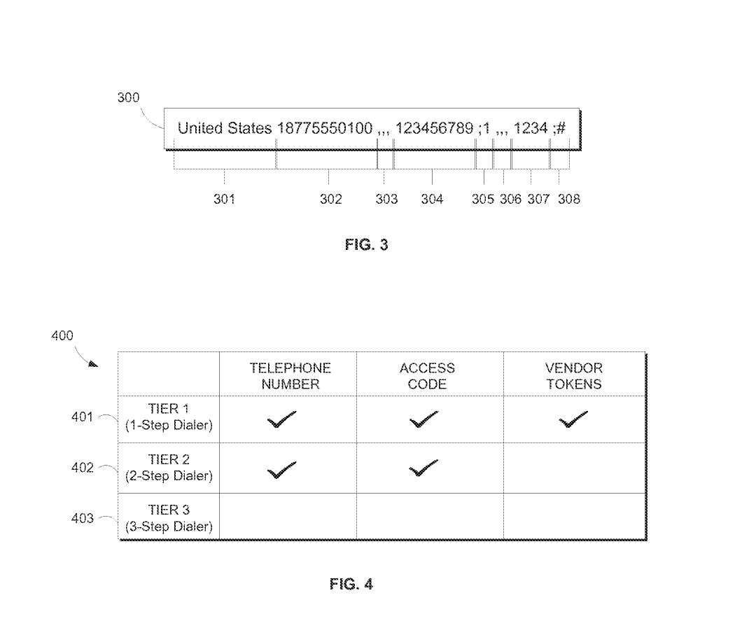

As a preliminary matter, FIG. 3 depicts an exemplary conference call format 300 useful for understanding the various embodiments described herein. More particularly, conference call ID format 300 includes a “label” 301, a conference call number 302, an access code 304, a pin number 307, and one or more vendor tokens or simply “tokens” 303, 305, 306, and 308. Label 301 may be any string of alphanumeric characters of a type that often precedes a valid conference number. In the illustrated embodiment, label 301 designates a country (“United States”). Other common labels include, without limitation, “Phone:”, “Phone Number:”, “Dial In:”, “Join by Phone:”, and “Toll”. Conference call number 302 includes a conventional telephone number of any appropriate length using any number of known, parseable formats, such as simple eleven digit (“18775550100”), simple ten digit (“8775550100”), and variations including various delimiters (“(877) 555-0100”, “877-555-0100”, and the like). Access code 304 corresponds to the access code (in any) that needs to be entered in order to participate in the meeting, either as a participant or the moderator. A nine-digit example is shown for access code 304, but any number of digits may be used in any particular case. Vendor tokens 303, 305, 306, and 308 include any special characters that might be used to establish the conference call, including pauses (e.g., a comma character indicating a predetermined pause, or a semicolon character indicating ‘stop and wait’, etc.), pound (“#”) signs, pin confirmation characters, and any other such character required by the conference call vendor associated with conference call format 300.

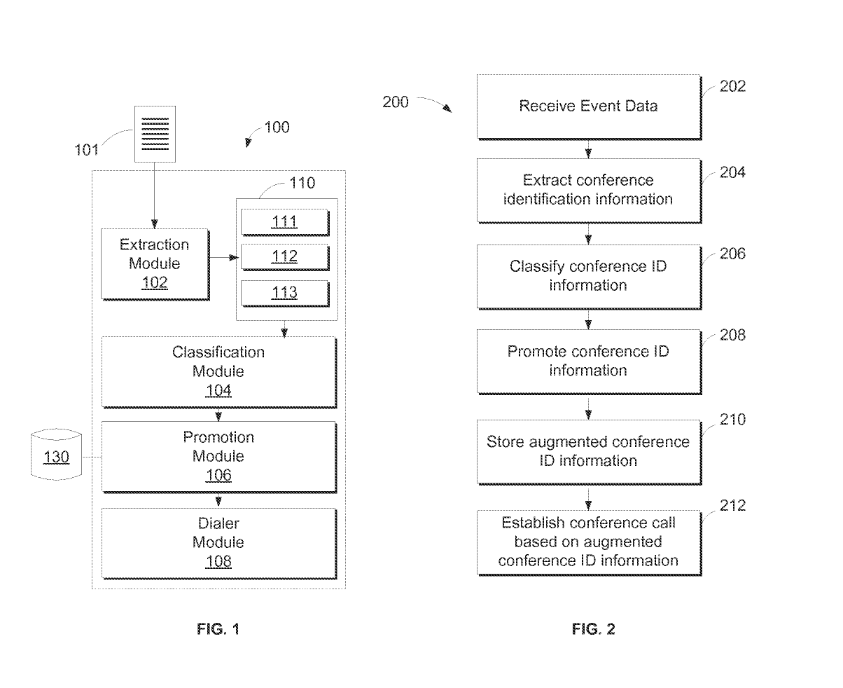

Referring now to the flowchart of FIG. 2 in conjunction with the conceptual block diagram of FIG. 1, an exemplary method 200 for establishing a conference call will now be described. First, in step 202, the system receives the conference call event data 101. As used herein, “event data” refers to any document or stream of alphanumeric characters that can be parsed to determine whether and to what extent that data identifies a particular conference. Event data 101 might include, for example, a text document, an e-mail document, a “note”, a calendar entry, a meeting notice, or a stream of text generated during runtime. For example, event data 101 might by a meeting notice that includes the text “Please dial in: 888-555-0100 Access code: 12345678”.

In step 204, conference ID information 110 is extracted from event data 101 (e.g., via extraction module 102). This extraction may be performed in a number of ways. In one embodiment, for example, event data 101 is tested against a predetermined list of regular expressions (“regex”) to spot commonly used patterns for specifying the nature of a conference call. Such regular expressions might include, for example, matching non-digit text of length greater than equal to two, followed by at least one space of colon, followed by any pattern of characters that would typically be allowed in a valid phone number, including digits, spaces, dashes, plus-signs, periods, and parenthesis). The library or set of regular expressions might also include “labels”, as described above, that would typically precede a valid telephone number (e.g., “Please Call:”) and/or a valid access code (e.g., “Your Access Code:”). As will be appreciated, such a process might produce a number of “false positives”—i.e., numbers that the system incorrectly identifies as phone numbers or access codes.

Extraction module 102 may be further configured to recognize vendor-specific conference ID information, such as a uniform resource locator (URL) corresponding to a known vendor, and for which the corresponding dialing format tokens are known. One such example is the commonly known GotoMeeting URL format, such as “https://www1.gotomeeting.com/join/123456789.” Similarly, extraction module 102 may be configured to recognize a string corresponding to a known, “one-dial” format, such as “18325551111 , , , 123456789;1”, which corresponds to a conference number “1832555111”, followed by three comma “pause” characters (e.g., a two-second pause per comma), followed by an access code (“123456789”), followed by a “stop and wait for user input” character (“;”), followed by a confirmation character “1”.

In one embodiment, the extracted conference ID information 100 includes three categories of information: a set of candidate conference numbers (111), a set of candidate access codes (112), and a set of dialing format tokens (113). In this regard, “set” refers to a collection of zero or more members. For example, set 111 might include two candidate conference numbers (“8325551111”, “:7895558987”), while set 112 includes no candidate access codes.

In Step 206, the conference ID information is classified in accordance with the sufficiency or “completeness” of the information. FIG. 4, for example, presents a conceptual table 400 including an exemplary multi-tier scheme for classifying conference ID information. In the illustrated embodiment, table 400 includes three tiers: tier 1 (401), tier 2 (402), and tier 3 (403). Tier 1 may be referred to as the “top” tier, while tiers 2 and tier 3 may be referred to as “lower” tiers. Tier 1 may be referred to as a “higher” tier than tier 2, and tier 2 may be referred to as a “higher” tier than tier 3. Tier 1 (401) corresponds to the case where a valid conference telephone number, a valid access code, and the appropriate vendor tokens are known. This is a “1-step dialer” case in that all information needed to establish the conference call is known a priori, and thus only a single user step (e.g., clicking a teleconference initiation button) is required. In contrast, Tier 2 (402) corresponds to the case where a valid conference telephone number and an associated valid access code is known, but the appropriate vendor tokens (which may be vendor-specific) are not known. Tier 3 (403) corresponds to the case where the system does not know the appropriate conference telephone number, its associated access code, or the appropriate vendor tokens to employ. As will be apparent, Tier 1 (401) is the most desirable tier. Accordingly, moving up table 400 from the bottom toward the top is generally referred to herein as “promotion”, as will be described in further detail below. It will be appreciated that any more or less than three tiers may be used, and further that storage of conference ID information and its associated tier may accomplished using any number of conventional data structures known in the art.

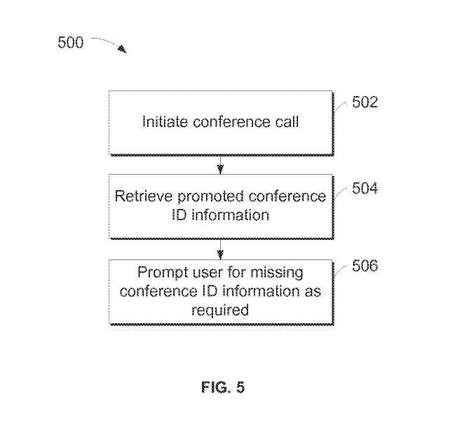

Referring again to the flowchart of FIG. 2, the process continues with step 208, which includes “promoting” the conference ID information 110 (e.g., filling in missing data) based on any available information (e.g., locally stored information regarding previous conference calls) and/or supplemental information provided by the user. For example, referring also to the multi-tier model of FIG. 4, the conference identification information may be promoted to second tier 402 from third tier 403, and/or may be promoted to first tier 401 from second tier 402. In an exemplary embodiment, the resulting promoted conference call identification information is stored locally (step 210 of FIG. 2) and then recalled when the user initiates the corresponding conference call. This process is shown in FIG. 5, which depicts an exemplary process for establishing a conference call in accordance with various embodiments, and includes initiating a conference call (502), retrieving promoted conference ID information (e.g., from local storage and/or an external database) (504), and then prompting the user for missing conference ID information (506). After which, the conference call may be established (Step 212 of FIG. 2) based on the augmented conference call identification information.

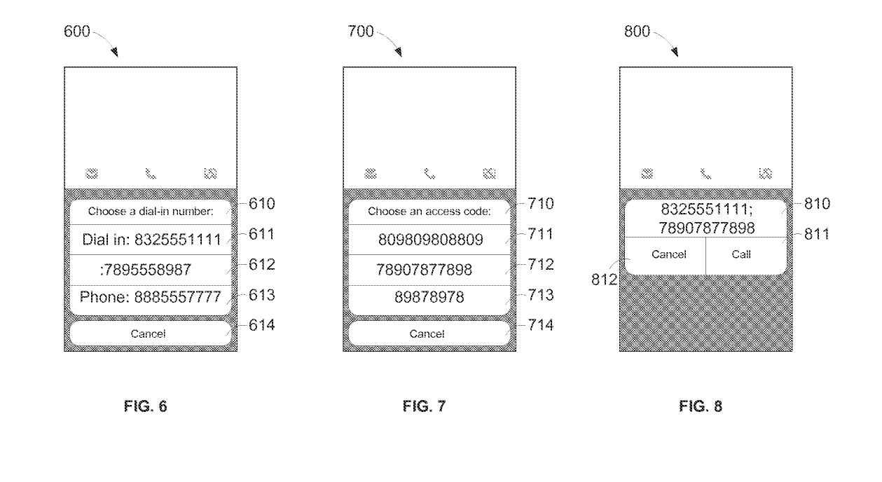

By way of example, FIGS. 6-8 depict an exemplary user interface provided to promote conference call identification information in accordance with various embodiments. That is, FIGS. 6-8 illustrate successive “screen shots” (600-800) as a user of a touch-screen mobile device or other computing device responds to the prompts necessary to complete the conference ID information. It will be appreciated that the various components of the user interface shown in FIGS. 6-8 are not intended to be limiting, and that a wide variety of user interfaces and prompting methods may be employed to aid with promoting the conference ID information.

FIG. 6 commences just after the user has initiated the conference call—e.g., by clicking on a link, interacting with one or more buttons, or the like. For example, in the case where event data 101 is included within an e-mail, a link within that e-mail (i.e., a URL) may be clicked by the user. Alternatively, the user may be presented with a button which, when clicked by the user, initiates the conference call, and the process described below. It will be appreciated that the embodiments are not limited by this example, which employs clickable links and buttons, and that a wide variety of user interface elements and methods may be used to initiate the conference call, such as voice commands and other interaction methods.

As mentioned above, the conference call information may be classified, in this embodiment, as either tier 1, tier 2, tier 3. For the purpose of this example, it is assumed that the conference call information is classified as tier 3—i.e., that neither the telephone number, access code, or vendor tokens are known by the system. The process flow for tiers 1 and 2 will also be described in further detail below.

Since the conference call information is classified as tier 3, the system recognizes that the text of the e-mail, calendar entry, etc. may contain one or more candidate phone numbers and/or access codes, but the system cannot yet determine which of those candidate phone numbers and/or access codes are necessary to complete the conference call. At this point, the system displays a prompt (e.g., a modal menu) including text requesting the dial-in number (610) along with a list depicting a set of candidate conference numbers 611, 612, 613 that may be selected (e.g., via a finger or other input object). As noted above, the candidate conference numbers 611, 612, 613 may be determined by parsing or otherwise analyzing the text of the event data 101 to extract such candidate conference number 611, 612, 613. For example, a set of regular expressions may be applied to the text, as is known in the art. The candidate conference numbers 611-613 correspond to all those numbers that have been extracted previously (e.g., by extraction module 102 of FIG. 1) from event data 101 for the particular user that received the invitation to the telephone conference. A “cancel” button may also be provided as shown to terminate the process (i.e., in the event that the user does not wish to proceed with the conference call).

After the user has selected one of the displayed conference numbers (e.g., conference number 611), the system prompts the user for access code information, as shown in FIG. 7. That is, the user is presented with text requesting an access code (710), a “cancel” option, as well as a list of candidate access codes 711-713. In this way, the system is capable of augmenting the original, incomplete conference call identification information with the supplemental information to produce augmented conference call identification information.

After selection of the appropriate access code (e.g., access code 712), a final dialog is presented to the user as shown in FIG. 8. At this point, the selected conference number and access code are displayed (810) to the user, who may then choose to cancel the call (812) or establish the call (811). The resulting set of conference call information is therefore “newly promoted” and “augmented” as it has been promoted from one tier to another (in this case from tier 3 to tier 1). The newly promoted conference call information may be stored for later use (e.g., locally within the user's device and/or at a remote server), thereby reducing or eliminating the need for the user to enter any further information (i.e., the conference ID information would then be considered “tier 1”).

In the event that the conference call information is initially categorized as “tier 2” (i.e., where both the access code and telephone number are known by the system), then the system may use any stored information regarding previous successful conference calls to determine the required vendor tokens. That is, the system may search such data for a matching telephone number (but not necessarily a matching access code), and then use the vendor token information (e.g., a “pause” token or the like) from that previously successful conference call to promote the conference call information to tier 1. The information regarding previously successful conference calls may be stored in a database that is available to all users, thus allowing each user to benefit from vendor token information compiled from a large number of users. Alternatively, the user may be prompted to select the appropriate vendor from the list, and then information regarding vendor tokens associated with that vendor may be used to produce the augmented conference call information.

Finally, in the event that the conference call information is initially categorized as “tier 1” (i.e., where all information regarding the conference call number is known), then the conference call may be established without further user interaction, or alternatively the user may be presented with a confirmation dialog as depicted in FIG. 8.

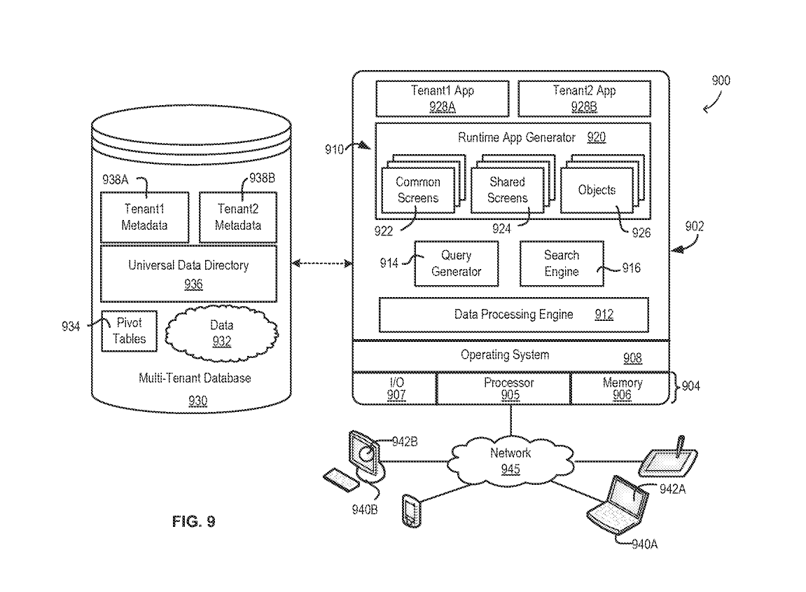

FIG. 9 depicts an exemplary multi-tenant system suitable for implementation of the conference call methods described herein. That is, the various devices 904 may be operated by a user wishing to establish a conference call, while the particular conference call ID information may be all or partially stored in multi-tenant database 930. In this regard, the illustrated multi-tenant system 900 of FIG. 6 includes a server 902 that dynamically creates and supports virtual applications 928 based upon data 932 from a common database 930 that is shared between multiple tenants, alternatively referred to herein as a multi-tenant database. Data and services generated by the virtual applications 928 are provided via a network 945 to any number of client devices 940, as desired. Each virtual application 928 is suitably generated at run-time (or on-demand) using a common application platform 910 that securely provides access to the data 932 in the database 930 for each of the various tenants subscribing to the multi-tenant system 900. In accordance with one non-limiting example, the multi-tenant system 900 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 930. In this regard, each tenant includes one or more users associated with, assigned to, or otherwise belonging to that respective tenant. To put it another way, each respective user within the multi-tenant system 900 is associated with, assigned to, or otherwise belongs to a particular tenant of the plurality of tenants supported by the multi-tenant system 900. Tenants may represent customers, customer departments, business or legal organizations, and/or any other entities that maintain data for particular sets of users within the multi-tenant system 900 (i.e., in the multi-tenant database 930). For example, the application server 902 may be associated with one or more tenants supported by the multi-tenant system 900. Although multiple tenants may share access to the server 902 and the database 930, the particular data and services provided from the server 902 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 932 belonging to or otherwise associated with other tenants.

The multi-tenant database 930 is any sort of repository or other data storage system capable of storing and managing the data 932 associated with any number of tenants. The database 930 may be implemented using any type of conventional database server hardware. In various embodiments, the database 930 shares processing hardware 904 with the server 902. In other embodiments, the database 930 is implemented using separate physical and/or virtual database server hardware that communicates with the server 902 to perform the various functions described herein. In an exemplary embodiment, the database 930 includes a database management system or other equivalent software capable of determining an optimal query plan for retrieving and providing a particular subset of the data 932 to an instance of virtual application 928 in response to a query initiated or otherwise provided by a virtual application 928. The multi-tenant database 930 may alternatively be referred to herein as an on-demand database, in that the multi-tenant database 930 provides (or is available to provide) data at run-time to on-demand virtual applications 928 generated by the application platform 910.

In practice, the data 932 may be organized and formatted in any manner to support the application platform 910. In various embodiments, the data 932 is suitably organized into a relatively small number of large data tables to maintain a semi-amorphous “heap”-type format. The data 932 can then be organized as needed for a particular virtual application 928. In various embodiments, conventional data relationships are established using any number of pivot tables 934 that establish indexing, uniqueness, relationships between entities, and/or other aspects of conventional database organization as desired. Further data manipulation and report formatting is generally performed at run-time using a variety of metadata constructs. Metadata within a universal data directory (UDD) 936, for example, can be used to describe any number of forms, reports, workflows, user access privileges, business logic and other constructs that are common to multiple tenants. Tenant-specific formatting, functions and other constructs may be maintained as tenant-specific metadata 938 for each tenant, as desired. Rather than forcing the data 932 into an inflexible global structure that is common to all tenants and applications, the database 930 is organized to be relatively amorphous, with the pivot tables 934 and the metadata 938 providing additional structure on an as-needed basis. To that end, the application platform 910 suitably uses the pivot tables 934 and/or the metadata 938 to generate “virtual” components of the virtual applications 928 to logically obtain, process, and present the relatively amorphous data 932 from the database 930.

The server 902 is implemented using one or more actual and/or virtual computing systems that collectively provide the dynamic application platform 910 for generating the virtual applications 928. For example, the server 902 may be implemented using a cluster of actual and/or virtual servers operating in conjunction with each other, typically in association with conventional network communications, cluster management, load balancing and other features as appropriate. The server 902 operates with any sort of conventional processing hardware 904, such as a processor 905, memory 906, input/output features 907 and the like. The input/output features 907 generally represent the interface(s) to networks (e.g., to the network 945, or any other local area, wide area or other network), mass storage, display devices, data entry devices and/or the like. The processor 905 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 906 represents any non-transitory short or long term storage or other computer-readable media capable of storing programming instructions for execution on the processor 905, including any sort of random access memory (RAM), read only memory (ROM), flash memory, magnetic or optical mass storage, and/or the like. The computer-executable programming instructions, when read and executed by the server 902 and/or processor 905, cause the server 902 and/or processor 905 to create, generate, or otherwise facilitate the application platform 910 and/or virtual applications 928 and perform one or more additional tasks, operations, functions, and/or processes described herein. It should be noted that the memory 906 represents one suitable implementation of such computer-readable media, and alternatively or additionally, the server 902 could receive and cooperate with external computer-readable media that is realized as a portable or mobile component or application platform, e.g., a portable hard drive, a USB flash drive, an optical disc, or the like.

The application platform 910 is any sort of software application or other data processing engine that generates the virtual applications 928 that provide data and/or services to the client devices 940. In a typical embodiment, the application platform 910 gains access to processing resources, communications interfaces and other features of the processing hardware 904 using any sort of conventional or proprietary operating system 908. The virtual applications 928 are typically generated at run-time in response to input received from the client devices 940. For the illustrated embodiment, the application platform 910 includes a bulk data processing engine 912, a query generator 914, a search engine 916 that provides text indexing and other search functionality, and a runtime application generator 920. Each of these features may be implemented as a separate process or other module, and many equivalent embodiments could include different and/or additional features, components or other modules as desired.

The runtime application generator 920 dynamically builds and executes the virtual applications 928 in response to specific requests received from the client devices 940. The virtual applications 928 are typically constructed in accordance with the tenant-specific metadata 938, which describes the particular tables, reports, interfaces and/or other features of the particular application 928. In various embodiments, each virtual application 928 generates dynamic web content that can be served to a browser or other client program 942 associated with its client device 940, as appropriate.

The runtime application generator 920 suitably interacts with the query generator 914 to efficiently obtain multi-tenant data 932 from the database 930 as needed in response to input queries initiated or otherwise provided by users of the client devices 940. In a typical embodiment, the query generator 914 considers the identity of the user requesting a particular function (along with the user's associated tenant), and then builds and executes queries to the database 930 using system-wide metadata 936, tenant specific metadata 938, pivot tables 934, and/or any other available resources. The query generator 914 in this example therefore maintains security of the common database 930 by ensuring that queries are consistent with access privileges granted to the user and/or tenant that initiated the request. In this manner, the query generator 914 suitably obtains requested subsets of data 932 accessible to a user and/or tenant from the database 930 as needed to populate the tables, reports or other features of the particular virtual application 928 for that user and/or tenant.

Still referring to FIG. 6, the data processing engine 912 performs bulk processing operations on the data 932 such as uploads or downloads, updates, online transaction processing, and/or the like. In many embodiments, less urgent bulk processing of the data 932 can be scheduled to occur as processing resources become available, thereby giving priority to more urgent data processing by the query generator 914, the search engine 916, the virtual applications 928, etc.

In exemplary embodiments, the application platform 910 is utilized to create and/or generate data-driven virtual applications 928 for the tenants that they support. Such virtual applications 928 may make use of interface features such as custom (or tenant-specific) screens 924, standard (or universal) screens 922 or the like. Any number of custom and/or standard objects 926 may also be available for integration into tenant-developed virtual applications 928. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 926 such as “account” objects, “opportunity” objects, “contact” objects, or the like. The data 932 associated with each virtual application 928 is provided to the database 930, as appropriate, and stored until it is requested or is otherwise needed, along with the metadata 938 that describes the particular features (e.g., reports, tables, functions, objects, fields, formulas, code, etc.) of that particular virtual application 928. For example, a virtual application 928 may include a number of objects 926 accessible to a tenant, wherein for each object 926 accessible to the tenant, information pertaining to its object type along with values for various fields associated with that respective object type are maintained as metadata 938 in the database 930. In this regard, the object type defines the structure (e.g., the formatting, functions and other constructs) of each respective object 926 and the various fields associated therewith.

Still referring to FIG. 6, the data and services provided by the server 902 can be retrieved using any sort of personal computer, mobile telephone, tablet or other network-enabled client device 940 on the network 945. In an exemplary embodiment, the client device 940 includes a display device, such as a monitor, screen, or another conventional electronic display capable of graphically presenting data and/or information retrieved from the multi-tenant database 930. Typically, the user operates a conventional browser application or other client program 942 executed by the client device 940 to contact the server 902 via the network 945 using a networking protocol, such as the hypertext transport protocol (HTTP) or the like. The user typically authenticates his or her identity to the server 902 to obtain a session identifier (“SessionID”) that identifies the user in subsequent communications with the server 902. When the identified user requests access to a virtual application 928, the runtime application generator 920 suitably creates the application at run time based upon the metadata 938, as appropriate. As noted above, the virtual application 928 may contain Java, ActiveX, or other content that can be presented using conventional client software running on the client device 940; other embodiments may simply provide dynamic web or other content that can be presented and viewed by the user, as desired.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to on-demand applications, telephonic communication, conference call systems, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of establishing a conference call, comprising:
extracting conference identification information from received event data, the conference identification information including a set of candidate conference numbers, a set of candidate access codes, and a set of dialing format tokens;
classifying, with a processor, the conference identification information into a plurality of tiers based on at least one of the set of candidate conference numbers including a valid conference number, the set of candidate access codes including a corresponding valid access code, and the set of dialing format tokens including a corresponding valid dialing format token; and
promoting the conference identification information to a higher tier of the plurality of tiers from a lower tier of the plurality of tiers by augmenting the conference call information with first supplemental information provided by a user and storing the augmented conference identification information in a database; and
establishing the conference call based on the augmented conference identification information.

2. The method of claim 1, further including:
promoting the conference identification information from the lower tier of the plurality of tiers to the higher tier of the plurality of tears based on the stored augmented conference identification information.

3. The method of claim 1, further including storing the classified conference identification information on a mobile computing device.

4. The method of claim 1, wherein the higher tier of the plurality of tiers corresponds to a case in which the set of candidate conference numbers includes a valid conference number, the set of candidate access codes includes a corresponding valid access code, and the set of dialing format tokens includes a corresponding valid dialing format token.

5. The method of claim 4, wherein the lower tier of the plurality of tiers corresponds to a case in which the set of candidate conference numbers includes a valid conference number, the set of candidate access codes includes a corresponding valid access code, and the set of dialing format tokens does not include a corresponding valid dialing format token.

6. The method of claim 5, wherein the plurality of tiers further includes a third tier corresponding to a case in which the set of candidate conference numbers includes a valid conference number, the set of candidate access codes does not include a corresponding valid access code, and the set of dialing format tokens does not include a corresponding valid dialing format token.

7. The method of claim 1, wherein extracting the conference identification information from the event data includes identifying a label preceding a candidate conference number.

8. The method of claim 1, wherein extracting the conference identification information includes identifying a known conference call format in the event data.

9. The method of claim 7, wherein the known conference call format includes a vendor-specific uniform resource locator.

10. A conference call management system comprising:
an extraction module configured to receive event data and extract conference identification information therefrom, the conference identification information including a set of candidate conference numbers, a set of candidate access codes, and a set of dialing format tokens;
a classification module configured to classify the conference identification information into a plurality of tiers based on the set of candidate conference numbers including a valid conference number, the set of candidate access codes including a corresponding valid access code, and the set of dialing format tokens including a corresponding valid dialing format token; and
a promotion module configured to promote the conference identification information to a higher tier of the plurality of tiers from a lower tier of the plurality of tiers by augmenting the conference identification information with first supplemental information provided by a user; and
a dialer module configured to establish the conference call based on the augmented conference identification information.

11. The system of claim 10, further including a server configured to store the augmented conference identification information, wherein the promotion module is further configured to promote the conference identification information from the lower tier of the plurality of tiers to the higher tier of the plurality of tears based on the stored augmented conference identification information.

12. The system of claim 10, wherein the higher tier of the plurality of tiers corresponds to a case in which the set of candidate conference numbers includes a valid conference number, the set of candidate access codes includes a corresponding valid access code, and the set of dialing format tokens includes a corresponding valid dialing format token.

13. The system of claim 12, wherein the lower tier of the plurality of tiers corresponds to a case in which the set of candidate conference numbers includes a valid conference number, the set of candidate access codes includes a corresponding valid access code, and the set of dialing format tokens does not include a corresponding valid dialing format token.

14. The system of claim 13, wherein the plurality of tiers further includes a third tier corresponding to a case in which the set of candidate conference numbers includes a valid conference number, the set of candidate access codes does not include a corresponding valid access code, and the set of dialing format tokens does not include a corresponding valid dialing format token.

15. The system of claim 10, wherein the extraction module is configured to extract the conference identification information from the event data by identifying at least one of a label preceding a candidate conference number and a known conference call format in the event data.

16. The system of claim 10, wherein the extraction module is an on-demand system, and the promoted conference identification information is stored in multi-tenant database.

17. A computing system comprising a processing system and a memory, wherein the memory comprises computer-executable instructions that, when executed by the processing system, cause the computing system to:
extract conference identification information from received event data stored in a database, the conference identification information including a set of candidate conference numbers, a set of candidate access codes, and a set of dialing format tokens;
classify the conference identification information into a plurality of tiers based on whether the set of candidate conference numbers includes a valid conference number, whether the set of candidate access codes includes a corresponding valid access code, and whether the set of dialing format tokens includes a corresponding valid dialing format token; and
promote the conference identification information to a higher tier of the plurality of tiers from a lower tier of the plurality of tiers by augmenting the conference identification information with first supplemental information provided by a user and storing the augmented conference identification information in the database.

18. The computing system of claim 17, wherein the computer-executable instructions further cause the computing system to:
store the augmented conference identification information; and
promote the conference identification information from the lower tier of the plurality of tiers to the higher tier of the plurality of tears based on the stored augmented conference identification information.

19. The computing system of claim 17, wherein the computer-executable instructions cause the computing system to extract the conference identification information from the event data by identifying at least one of a label preceding a candidate conference number and a known conference call format in the event data.

20. The computing system of claim 17, wherein the conference identification information is stored in multi-tenant database.
